(19) United States
(12) Patent Application Publication
(10) Pub. No.: US 2003/0161935 A1
(43) Pub. Date: Aug. 28, 2003

(54) Process for preparing high liquid oil margarine

(76) Inventors: Yukio Kakuda, Guelph (CA); Abraham Brampton, Ontario (CA); Firouz Jahan-Aval, Ontario (CA)

Correspondence Address: BERESKIN AND PARR, SCOTIA PLAZA, 40 KING STREET WEST-SUITE 4000 BOX 401, TORONTO, ON, M5H 3Y2, CA

(21) Appl. No.: 10/257,379

(22) PCT Filed: Apr. 20, 2001
(86) PCT No.: PCT/CA01/00532

(51) Int. Cl. A23D 7/06

(52) U.S. Cl. 426/604

(57) ABSTRACT

The present invention provides a high liquid oil margarine wherein the total fat content of said high liquid oil margarine is made up of about 95% liquid oil and a maximum of about 5% added hard fat and processes for preparing such margarines. The processes of the invention comprise both batch and continuous processes applied to the preparation of an oil-in-water-in-oil emulsion by mixing a first oil-in-water emulsion with a second oil-in-water emulsion, at a temperature above the crystallization temperature of the added hard fat, wherein said first oil-in-water emulsion may comprise about 55%-80% of the total liquid oil and said second oil-in-water emulsion may comprise about 20%-45% of the total liquid oil and essentially all of the added hard fat, reducing said temperature until a phase transition occurs, and supercooling and mixing to obtain a high liquid oil margarine. The process of the invention does not require the use of interesterification procedures and provides a margarine comprising low levels saturated fats and virtually no trans fatty acids.

### FIELD OF THE INVENTION

The present invention is in the field of food preparation, particularly in the preparation of comestible healthy spreads, for example healthy substitutes for butter and margarine.

### BACKGROUND OF THE INVENTION

Margarine, by definition, contains at least 80% fat by weight. Most margarines comprise a water phase and an oil phase which are emulsified and therefore are in the form of a water-in-oil emulsion. The preparation of margarine using traditional manufacturing procedures involves preparing an emulsion comprising 20% aqueous phase (with a maximum water content of 16%) and 80% fat phase according to traditional processes. This emulsion is rapidly cooled in a scraped surface heat exchanger (for example, an “A” unit of a Votator) to achieve nucleation. In the second “B” unit, the mass is worked vigorously to complete crystal formation then allowed to rest to achieve phase stabilization prior to packaging. Equipment of this type (for example, a votator) involves considerable capital expenditure, residence times that are relatively lengthy and substantial energy and/or operating costs.

In recent years, it has become known that the “unhealthy” fats in margarine are saturated and trans fatty acids. The concern about saturated fatty acids was initially addressed when the industry launched soft tub margarines. These products were highly successful and captured a major share of the market by replacing the highly saturated fatty acid-containing stick margarines. Most margarines on the market today, however, are manufactured with partially hydrogenated fats and as a consequence can still contain substantial quantities of trans and saturated fatty acids. For tub-type margarines, a typical composition of the fat phase is 33-52% monounsaturated fat, 29-48% polyunsaturated fat and 17-19% saturated fat. In fat compositions falling within these ranges, the emulsion need not be very stable against coalescence as the water droplets become trapped within the solid, saturated fat crystal network during preparation. Water droplets in the finished margarine are stabilized by adsorbed fat crystals oriented flatly along their surface. In formulations with less than 17-19% saturated fat, the stability of the finished margarine would be reduced due to the lack of a sufficient crystal network to hold the water droplets and free liquid oil. Using the traditional margarine manufacturing procedures, it would be impossible to prepare a stable margarine with the texture and mouth feel of a commercial tub-type margarine if the fat phase contained less than 10%-13% saturated fats. Although a margarine having a fat phase comprising 10%-13% saturated fat may be prepared if the saturated fats include 2%-5% mono- and diacylglycerides with high melting point fatty acids having carbon chains as long as C22 mixed with fatty acids having carbon chains between C18-C14, such a margarine would have a high polarity and high melting point and thus would have poor mouth feel and questionable healthiness.

Recent introduction of spreads which are manufactured using a non-traditional manufacturing process involving interesterified fats, has provided margarine products with almost no trans fatty acids and around 10-11% saturated fats. Interesterification modifies a fat to increase its melting point, however the process of interesterification is expensive, adding significant costs to the manufacture of such products.

There remains a need for a simple and economical process to produce a margarine containing virtually no trans fatty acids and minimal amounts of saturated fats. Such a process should preferably not require the use of interesterified fats.

### SUMMARY OF THE INVENTION

The present invention provides a process, which may be operated as a batch and/or continuous process, and/or combinations thereof, for preparing a high liquid oil margarine wherein the total fat content comprises a maximum of about 4-6% of one or more added hard fats and about 94-96% of one or more liquid oils, such margarine having less than about 0.1% trans fatty acids. This provides a margarine having a final composition made up of approximately 3-5% (by weight) of one or more added hard fats. The process of the invention does not require the use of interesterification procedures.

In one of its aspects, the present invention provides a process for the preparation of a high liquid oil margarine wherein the total fat content of the margarine comprises about 94-96% of one or more liquid oils and a maximum of about 4-6% of one or more added hard fats, the process comprising the steps of:

(I) combining a first oil-in-water emulsion and a second oil-in-water emulsion at a temperature above the crystallization temperature of the one or more added hard fats and mixing to provide a mixture, wherein said first oil-in-water emulsion comprises between about 55% to about 80% of total liquid oil in the margarine and the second oil-in-water emulsion comprises between about 20% to about 45% of total liquid oil in the margarine and essentially all of the one or more added hard fats in the margarine;

(II) reducing the temperature of the mixture and mixing until a phase transition occurs; and

(III) supercooling and mixing to obtain a high liquid oil margarine.

In another aspect of the present invention there is provided a process for the preparation of a high liquid oil margarine wherein the total fat content of the margarine comprises about 94-96% of one or more liquid oils and a maximum of about 4-6% of one or more added hard fats, comprising the steps of:

(I) preparing a first oil-in-water emulsion comprising the steps of:

(a) providing an aqueous phase comprising about 2%-4% by weight of one or more water soluble emulsifying agents, about 0.1%-0.2% by weight of one or more preservatives and the remainder being essentially water;

(b) providing an oil phase comprising about 0.05%-0.4% by weight of one or more oil soluble emulsifying agents, about 0.3%-0.5% by weight of one or more flavouring agents and the remainder being essentially one or more liquid oils; and

(c) combining the oil phase and the aqueous phase at a temperature in the range of about 40° C. to about 80° C. to provide the first oil-in-water emulsion;

wherein the aqueous phase of the first oil-in-water emulsion comprises about 45%-55% of total water in the margarine and the oil phase of the first oil-in-water emulsion comprises about 55%-80% of total liquid oil in the margarine;

(II) preparing a second oil-in-water emulsion comprising the steps of:

(a) providing an aqueous phase comprising about 2%-4% by weight of one or more water soluble emulsifying agents, about 0.1%-0.2% by weight of one or more preservatives, about 10%-13% by weight of sodium chloride, about 13%-15% by weight of one or more flavouring agents and the remainder being essentially water;

(b) providing an oil phase comprising about 11%-15% by weight of one or more added hard fats, about 0.2%-0.6% by weight of one or more oil soluble emulsifying agents, 0.1%-0.3% by weight of one or more crystal modifiers and the remainder being essentially one or more liquid oils; and

(c) combining the oil phase and the aqueous phase, while both phases are kept at a temperature above the crystallization temperature of the one or more added hard fats, to provide the second oil-in-water emulsion;

wherein the aqueous phase of the second oil-in-water emulsion comprises about 45%-55% of total water in the margarine and the oil phase of the second oil-in-water emulsion comprises about 20%-45% of total liquid oil in the margarine and essentially all of the one or more added hard fats in the margarine;

(III) combining the first oil-in-water emulsion and the second oil-in-water emulsion, while keeping both emulsions at a temperature above the crystallization temperature of the one or more added hard fats, to produce a mixture;

(IV) reducing the temperature of the mixture and mixing until a phase transition occurs; and

(V) supercooling the mixture and mixing to obtain a high liquid oil margarine.

The invention further provides a process for the preparation of a high liquid oil margarine wherein the total fat content of the margarine comprises about 94-96% of one or more liquid oils and a maximum of about 4-6% of one or more added hard fats, the process comprising the steps of:

(I) combining a second oil phase and a first oil-in-water emulsion at a temperature above the crystallization temperature of the added one or more hard fats to provide a final oil-in-water emulsion, wherein said first oil-in-water emulsion comprises about 55-80% of total liquid oil in the margarine and essentially all of the water in the margarine and the second oil phase comprises about 20-45% of total liquid oil in the margarine and essentially all of the one or more added hard fats in the margarine, to provide a final oil-in-water emulsion; and

(II) supercooling the final oil-in-water emulsion and mixing to obtain a high liquid oil margarine.

In a further aspect of the present invention there is provided a process for the preparation of a high liquid oil margarine wherein the total fat content of the margarine comprises about 94%-96% of one or more liquid oils and a maximum of about 4%-6% of one or more added hard fats, the process comprising the steps of

(I) preparing a first oil-in-water emulsion comprising the steps of:

(a) providing an aqueous phase comprising about 2.5%-10% by weight of one or more water soluble emulsifying agents, about 0.1%-0.2% by weight of one or more preservatives, about 6.2%-12.5% by weight of sodium chloride, about 6.2%-12.5% by weight of whey powder and the remainder being essentially water;

(b) providing a first oil phase comprising about 0.05%-0.4% by weight of one or more oil soluble emulsifying agents, about 0.3%-0.5% by weight of one or more flavouring agents and the remainder being essentially one or more liquid oils; and

(c) combining the first oil phase and the aqueous phase at a temperature in the range of about 40° C. to about 80° C. to provide the first oil-in-water emulsion;

wherein the aqueous phase comprises essentially all of the water in the margarine and the first oil phase comprises about 55%-80% of total liquid oil in the margarine;

(II) providing a second oil phase comprising about 11%-15% by weight of one or more added hard fats, about 0.2%-0.6% by weight of one or more oil soluble emulsifying agents, 0.1%-0.3% by weight of one or more crystal modifiers, and the remainder being essentially one or more liquid oils;

wherein the second oil phase comprises about 20%-45% of total liquid oil in the margarine and essentially all of the added hard fats in the margarine;

(III) combining the first oil-in-water emulsion and the second oil phase while keeping the first oil-in-water emulsion and the second oil phase at a temperature above the crystallization temperature of the one or more added hard fats, to provide a final oil-in-water emulsion; and

(IV) supercooling the final oil-in-water emulsion and mixing to obtain a high liquid oil margarine.

In another of its aspects, the present invention provides a high liquid oil margarine wherein the total fat content of said high liquid oil margarine is made up of about 94-96% of one or more liquid oils and a maximum of about 4-6% of one or more added hard fats.

Preferably, the present invention provides a high liquid oil margarine wherein the total fat content of said high liquid oil margarine is made up of about 95% of one or more liquid oils and a maximum of about 5% of one or more added hard fats.

These and other aspects of the present invention are described in greater detail herein below.

### DETAILED DESCRIPTION OF THE INVENTION

The present invention provides simple and economical processes to produce a margarine containing virtually no trans fatty acids and minimal amounts of saturated fats. Therefore, the present invention provides a process, which may be operated as a batch and/or continuous process, and/or combinations thereof, for preparing a high liquid oil margarine wherein the total fat content comprises a maximum of about 4-6% of one or more added hard fats and about 94-96% of one or more liquid oils, such margarine having less than about 0.1% trans fatty acids. This provides a margarine having a final composition made up of approximately 3-5% (by weight) one or more added hard fats. The process of the invention does not require the use of interesterification procedures.

The term “high liquid oil margarine” refers to a margarine wherein the total fat of the margarine comprises greater than about 80% of one or more liquid oils and wherein the product has sufficient hardness at room temperature for use as a spreadable, tub-type margarine.

As used herein, the term “liquid oil” is understood to mean a mixture of triglycerides which is a liquid at temperatures of greater than about 5-10° C. Examples of such oils include, but are not limited to, canola oil, high oleic sunflower oil, sunflower oil, safflower oil, fish oil, soybean oil, cotton oil, corn oil, olive oil, peanut oil and mixtures thereof. Preferred liquid oils include canola oil, high oleic sunflower oil, sunflower oil, safflower oil, corn oil, and mixtures thereof. A particularly preferred liquid oil is canola oil.

The term “hard fat” as used herein refers to a fat comprising at least about 98-99% of a fully saturated (hydrogenated) fat and wherein the total level of trans-fatty acid present is between about 0-1%. Fully saturated fats are substantially free of trans fatty acids, although low levels of trans fatty acids may be formed in or be present in such fats. Such hard fats will be solid at temperatures below about 35-40° C. The term “one or more added hard fats” as used herein refers specifically to the one or more hard fats added to the one or more liquid oils to make up the total fat of the high liquid oil margarine. It differs from the small amounts of saturated fatty acids found naturally in liquid oil triacylglycerides. Examples of suitable hard fats include, but are not limited to, palm stearin, cotton stearin, corn stearin, canola stearin and mixtures thereof. Preferred are mixtures containing palm stearin and another stearin. Most preferred are mixtures of palm stearin plus cotton stearin and palm stearin plus canola stearin.

The term “supercooling” as used herein means to cool a mixture and/or an emulsion below the crystallization temperature of the one or more added hard fats.

The term “virtually no trans fatty acids” as used herein in reference to the final margarine product, means a margarine comprising less than about 0.1-1%, preferably less than about 0.1%, trans fatty acids.

All percentages used herein refer to a percentage of the weight of a specified mixture, component of the margarine or the margarine itself.

The term “total liquid oil” as used herein refers to the total amount of the one or more liquid oils in the margarine.

The term “total water” as used herein refers to the total amount of water in the margarine.

The term “total hard fat” as used herein refers to the total amount of the one or more hard fats in the margarine.

The process of the invention includes both batch and continuous processes. As used herein, the term “batch process” means a process where margarine is produced in distinct lot sizes. For example, a batch process may be a process wherein all of the reactants (in this case, the first and second oil-in-water emulsions) are introduced into a reactor at the beginning of the process and the reactants are then processed together, substantially without any material being added to or removed from the reactor, until the margarine is prepared. A batch process may be employed, for example, when there are limited quantities of the first and/or second emulsions. The term “continuous process” as used herein means a process where the margarine is produced in-line. For example, a continuous process may be a process wherein reactants are introduced and product is withdrawn, simultaneously in a continuous manner, from the reactor. The process of the invention also includes semicontinuous processes, wherein some of the reactants are added during the process and/or some of the product is removed during the process.

Stabilization of the high liquid oil margarine, with a total fat content made up of only about 4-6% of one or more added hard fats and about 94-96% of one or more liquid oils, is based on the use of suitable emulsifying agents, fat crystals and the mixing of two emulsions using the appropriate rates and temperatures. The amount of free liquid oil is reduced by forming two oil-in-water emulsions and mixing the two using the appropriate rate and temperature. By stabilizing about 55%-80% of the one or more liquid oils in a first oil-in-water emulsion, the remaining 20-45% of the liquid oils, containing about 3-5% of one or more added hard fats, can be stabilized in a second oil-in-water emulsion. In the process of the invention involving a first oil-in-water emulsion and a second oil phase, the second oil-in-water emulsion is formed within the first oil-in-water emulsion.

Process Using First and Second Oil-in-Water Emulsions

In one aspect of the present invention, there is provided a process for the preparation of a high liquid oil margarine wherein the total fat content of the margarine comprises about 94-96% of one or more liquid oils and a maximum of about 4-6% of one or more added hard fats, the process comprising the steps of:

(I) combining a first oil-in-water emulsion and a second oil-in-water emulsion at a temperature above the crystallization temperature of the one or more added hard fats and mixing to provide a mixture, wherein said first oil-in-water emulsion comprises between about 55% to about 80% of total liquid oil in the margarine and the second oil-in-water emulsion comprises between about 20% to about 45% of total liquid oil in the margarine and essentially all of the one or more added hard fats in the margarine;

(II) reducing the temperature of the mixture and mixing until a phase transition occurs; and

(III) supercooling and mixing to obtain a high liquid oil margarine.

In an embodiment of the invention, the first oil-in-water emulsion comprises about 55%-80%, preferably about 60%, of total liquid oil in the margarine, about 45%-55%, preferably about 50%, of total water in the margarine, one or more water soluble emulsifying agents and one or more fat soluble emulsifying agents. Other additives, typically used in the preparation of comestible spreads, may also be added. Such additives include, but are not limited to, colouring agents, flavouring agents, other emulsifiers, crystal modifiers, salt (sodium chloride) and preservatives.

To prepare the first oil-in-water emulsion, the oil phase and the aqueous phase are preferably provided separately. In an embodiment of the invention, the oil phase for the first oil-in-water emulsion further comprises (as a percentage by weight of this oil phase only) 0.05%-0.4%, preferably about 0.1%, by weight of one or more oil soluble emulsifying agents, about 0.3%-0.5%, preferably about 0.4%, by weight of one or more flavouring agents, preferably butter flavour and the remainder being essentially one or more liquid oils. Oil soluble emulsifying agents may be any suitable oil soluble emulsifying agent, including one or more of lecithin, phospholipids, monoglyceride and diglyceride, with lecithin being preferred. The oil phase can be prepared by adding the oil soluble emulsifying agents and flavouring agents in the one or more liquid oils, preferably canola oil, in any order, with thorough mixing and optional warming.

In another embodiment of the invention, the aqueous phase for the first oil-in-water emulsion further comprises (expressed as a percentage by weight of this aqueous phase only) about 2%-4%, preferably about 3%, by weight of one or more water soluble emulsifying agents, about 0.1%-0.2%, preferably about 0.18%, by weight of one or more preservatives and the remainder being essentially water. Water soluble emulsifying agents may be selected from any suitable water soluble emulsifying agent, including one or more of sodium caseinate, whey protein isolates and soy protein isolates. The preferred water soluble emulsifying agent is sodium caseinate. Preservatives may be selected from any suitable preservative, including one or more of sodium benzoate, calcium sorbate and potassium sorbate, with sodium benzoate being preferred. The aqueous phase may be prepared by warming the water to a temperature in the range of 40° C. to 80° C. (while not exceeding 80° C.), preferably at about 45° C.-55°C., adding, in any order, the emulsifying agent(s) and preservative(s) and mixing until everything is dissolved.

To prepare the first oil-in-water emulsion, the oil phase is preferably added to the warmed aqueous phase gradually and with mixing. The addition rate can be in the range of about 18-22 mL/min, preferably about 20 mL/min, and the mixing speed can be in the range of about 19,000-21,000 rpm, preferably at about 20,000 rpm, when the total volume of the first oil-in-water emulsion is about 50 mL. The addition rates, mixing speeds and mixing shears may vary depending on the volumes of the oil and water phases. A person skilled in the art would be able to determine the proper addition rates, mixing speeds and mixing shears for a particular volume of material by adjusting the addition rates, mixing speeds and shear forces during the mixing of the oil phase and the aqueous phase and using an addition rate, mixing speed and shear force that allows a stable emulsion to form.

In an embodiment of the invention, the second oil-in-water emulsion comprises about 20%-45%, preferably about 40%, of total liquid oil in the margarine, about 45%-55%, preferably about 50%, of total water in the margarine, essentially all of the added hard fats in the margarine, one or more water soluble emulsifying agents and one or more oil soluble emulsifying agents. Other additives, typically used in the preparation of comestible spreads, may also be added to this emulsion. Such additives include, but are not limited to, colouring agents, flavouring agents, other emulsifiers, crystal modifiers, salt and preservatives.

To prepare the second oil-in-water emulsion, the oil phase and the aqueous phase are preferably prepared separately. In a further embodiment of the invention, the oil phase of the second oil-in-water emulsion further comprises (expressed as a percentage by weight of this oil phase only) about 0.2%-0.6%, preferably about 0.3%, by weight of one or more oil soluble emulsifying agents, about 0.1%-0.3%, preferably about 0.15%, by weight of one or more crystal modifiers, preferably sorbitan tristearate, about 9%-15% by weight of one or more added hard fats, about 0.005%-0.02%, preferably about 0.01%, by weight of one or more colouring agents and the remainder being essentially one or more liquid oils. The amount of one or more added hard fats is about 4-6%, preferably about 5%, of the total fat in the final product (or about 3-5%, preferably about 4%, of the total weight of the final product). The oil soluble emulsifying agents may be selected from any suitable oil soluble emulsifying agents, for example one or more of lecithin, phospholipids, monoglyceride and diglyceride. Preferably the oil soluble emulsifying agents are lecithin and monogylceride. Suitable colouring agents include beta-carotene and annatto, with beta-carotene being preferred. The oil phase may be prepared by adding, in any order, the hard fat(s), oil soluble emulsifying agent(s), crystal modifier(s) and colouring agent(s) to the one or more liquid oils, at temperature in the range of 40° C.-80° C., preferably at about 45° C.-55° C., and mixing thoroughly until everything has dissolved.

In another embodiment of the present invention, the aqueous phase of the second oil-in-water emulsion further comprises (expressed as a percentage by weight of this aqueous phase only) about 2%-4%, preferably about 3%, by weight of one or more water soluble emulsifying agents, about 0.1%-0.2%, preferably about 0.14%, by weight of one or more preservatives, about 10%-13%, preferably about 11%, by weight, sodium chloride, about 10%-15%, preferably about 14%, by weight of one or more flavouring agents, such as whey powder and the remainder being essentially water. Water soluble emulsifying agents may be selected from any suitable water soluble emulsifying agent, including one or more of sodium caseinate, whey protein isolates and soy protein isolates. The preferred water soluble emulsifying agent is sodium caseinate. Preservatives may be selected from any suitable preservatives, including sodium benzoate, calcium sorbate and potassium sorbate, with sodium benzoate being preferred. The aqueous phase may be prepared by warming the water to a temperature in the range of about 40° C. to 80° C. (while not exceeding 80° C.), preferably at about 45° C.-55° C., adding, in any order, the one or more water soluble emulsifying agents, one or more preservatives, sodium chloride and one or more flavouring agents and mixing until everything is dissolved.

To prepare the second oil-in-water emulsion, the warmed oil phase is preferably added to the warmed aqueous phase gradually and with constant mixing while keeping the temperature in the range of 40° C. to 80° C. (while not exceeding 80° C.), preferably at about 45° C.-55° C. The preferred addition rate can be in the range of about 18-22 mL/min, preferably about 20 mL/min, and the mixing speed can be in the range of about 19,000-21,000 rpm, preferably at about 20,000 rpm when the total volume of the second oil-in-water emulsion is about 50 mL. The addition rates, mixing speeds and mixing shears may vary depending on the volumes of the oil and water phases. A person skilled in the art would be able to determine the proper addition rates, mixing speeds and mixing shears for a particular volume of material by adjusting the addition rates, mixing speeds and shear forces during the mixing of the oil phase and the aqueous phase and using an addition rate, mixing speed and shear force that allows a stable emulsion to form. The second oil-in-water emulsion is less stable than the first oil-in-water emulsion and a person skilled in the art will appreciate the level and degree of care which must be taken to prevent phase separation.

The first oil-in-water emulsion is mixed with the second oil-in-water emulsion while maintaining a temperature in the range of 40° C. to 80° C., preferably at about 45° C.-55° C. (making sure not to drop below the crystallization temperature of the one or more added hard fats), to provide a mixture. The order of addition is not critical at this stage, therefore the first oil-in-water emulsion may be added to the second oil-in-water emulsion or the second oil-in-water emulsion may be added to the first oil-in-water emulsion. The resulting mixture is then mixed at the proper mixing speeds and mixing shears, and at a temperature in the range of 40° C. to 80° C., preferably at about 45° C.-55° C. (making sure not to drop below the crystallization temperature of the one or more added hard fats) until the two emulsions are completely mixed. For a volume of about 100 mL, the time period to allow complete mixing of the two emulsions is about 1-5 min., suitably 2-3 min. This time period will increase as the volume of the mixture increases. A person skilled in the art would be able to recognize when the two emulsions are completely mixed.

Preferably, the temperature of the mixture is then gradually lowered, with continuous mixing, until a phase transition occurs. The temperature may need to be lowered to a temperature in the range of about 15° C.-35° C., suitably 20° C.-30° C. The phase transition can be recognized by a significant drop in viscosity and a change in colour from white to off-yellow. At this point the mixture must be quickly supercooled. Supercooling may be achieved using any suitable method, such as immersing the mixture into an ice/salt water bath or using a votator set at a temperature of about −5° C. to −15° C. Both methods will efficiently supercool the mixture, however, it is important to note that the use of an expensive votator is optional. While not wishing to be limited by theory, it is believed that supercooling crystallizes the hard fat and stabilizes the released liquid oil (continuous oil phase) within a fat crystal network providing an oil-in-water-in-oil emulsion. Continuous supercooling and mixing is performed until the desired hardness and texture of the high liquid oil margarine is obtained. The desired hardness and texture is one that is suitable for spreadable tub-type margarines.

Mixing all of the above emulsions can be performed using any mechanical mixing apparatus in which the mixing or homogenization speed and shear can be controlled. A preferred mixing apparatus is a polytron or piston homogenizer.

In an embodiment of the present invention, the process involving first and second oil-in-water emulsions maybe applied to batch processing methods, wherein the first and second emulsions are prepared and/or provided in separated holding tanks. One emulsion may then be added to the other emulsion or the two emulsion may be combined in further holding tank, followed by cooling and supercooling with mixing to provide the final product. Once the two emulsions are combined in the supercooling/mixing unit, no further reactants are added or removed from the unit until the final product is obtained. The final product may then be removed from the supercooling/mixing unit using any suitable means, and be packaged using standard packaging equipment.

Process Using a First Oil-in-Water Emulsion and a Second Oil Phase

In another aspect of the present invention there is provided a process for the preparation of a high liquid oil margarine wherein the total fat content of the margarine comprises about 94-96% of one or more liquid oils and a maximum of about 4-6% of one or more added hard fats, the process comprising the steps of:

I) combining a second oil phase and a first oil-in-water emulsion at a temperature above the crystallization temperature of the added one or more hard fats to form a final oil-in-water emulsion, wherein said first oil-in-water emulsion comprises about 55-80% of total liquid oil in the margarine and essentially all of the water in the margarine and the second oil phase comprises about 20-45% of total liquid oil in the margarine and essentially all of the one or more added hard fats in the margarine, to provide a final oil-in-water emulsion; and

(II) supercooling the final oil-in-water emulsion and mixing to obtain a high liquid oil margarine.

In an embodiment of the invention, the first oil-in-water emulsion comprises about 55%-80%, preferably about 60%, of total liquid oil in the margarine, essentially all of the water in the margarine, one or more water soluble emulsifying agents and one or more fat soluble emulsifying agents. Other additives, typically used in the preparation of comestible spreads, may also be added. Such additives include, but are not limited to, colouring agents, flavouring agents, other emulsifiers, crystal modifiers, salt (sodium chloride) and preservatives.

To prepare the first oil-in-water emulsion, a first oil phase and an aqueous phase are preferably provided separately. In an embodiment of the invention, the first oil phase further comprises (as a percentage by weight of this oil phase only) 0.05%-0.4%, preferably about 0.1%, by weight of one or more oil soluble emulsifying agents, about 0.3%-0.5%, preferably about 0.4%, by weight of one or more flavouring agents, preferably butter flavour and the remainder being essentially one or more liquid oils. Oil soluble emulsifying agents may be any suitable oil soluble emulsifying agent, including one or more of lecithin, phospholipids, monoglyceride and diglyceride, with lecithin being preferred. The first oil phase can be prepared by adding the oil soluble emulsifying agents and butter flavour in the one or more liquid oils, preferably canola oil, in any order, with thorough mixing and optional warming until all solids have dissolved.

In another embodiment of the invention, the aqueous phase for the first oil-in-water emulsion further comprises (expressed as a percentage by weight of this aqueous phase only) about 2.5%-10%, preferably about 2.5%, by weight of one or more water soluble emulsifying agents, about 0.1%-0.2%, preferably about 0.15%, by weight of one or more preservatives, about 6.2%-12.5%, preferably about 7%, by weight of sodium chloride, about 6.2%-12.5%, preferably about 8.5%, by weight of whey powder and the remainder being essentially water. Water soluble emulsifying agents may be selected from any suitable water soluble emulsifying agent, including one or more of sodium caseinate, whey protein isolates and soy protein isolates. The preferred water soluble emulsifying agent is sodium caseinate. Preservatives may be selected from any suitable preservative, including one or more of sodium benzoate, calcium sorbate and potassium sorbate, with sodium benzoate being preferred. The aqueous phase may be prepared by warming the water to a temperature in the range of 40° C. to 80° C. (while not exceeding 80° C.), preferably at about 45° C.-55° C., adding, in any order, the emulsifying agent(s) and preservative(s) and mixing until everything is dissolved.

To prepare the first oil-in-water emulsion, the first oil phase is preferably added to the warmed aqueous phase gradually and with mixing. The addition rate can be in the range of about 18-22 mL/min, preferably about 20 mL/min, and the mixing speed can be in the range of about 19,000-21,000 rpm, preferably at about 20,000 rpm, when the total volume of the first oil-in-water emulsion is about 50 mL. The addition rates, mixing speeds and mixing shears may vary depending on the volumes of the oil and water phases. A person skilled in the art would be able to determine the proper addition rates, mixing speeds mixing shears for a particular volume of material by adjusting the addition rates, mixing speeds and shear forces during the mixing of the oil phase and the aqueous phase and using an addition rate, mixing speed and shear force that allows a stable emulsion to form.

In an embodiment of the present invention, the second oil phase comprises (expressed as a percentage by weight of the second oil phase only) about 11%-15%, preferably about 11-12%, of one or more added hard fats, 0.2%-0.4%, preferably about 0.3%, by weight of one or more oil soluble emulsifying agents, about 0.1%-0.3%, preferably about 0.15%, by weight of one or more crystal modifiers, preferably sorbitan tristearate, about 0.005%-0.002%, preferably about 0.01%, by weight of one or more colouring agents and the remainder being essentially one or more liquid oils. The amount of one or more added hard fats is about 4-6%, preferably about 5%, of the total fat in the final product (or about 3-5%, preferably about 4%, of the total weight of the final product). The oil soluble emulsifying agents may be selected from any suitable oil soluble emulsifying agents, for example one or more of lecithin, phospholipids, monoglyceride and diglyceride. Preferably the oil soluble emulsifying agents are lecithin and monogylceride. Suitable colouring agents include beta-carotene and annatto, with beta-carotene being preferred. The oil phase may be prepared by adding, in any order, the hard fat(s), oil soluble emulsifying agent(s), crystal modifier(s) and colouring agent(s) to the one or more liquid oils, at temperature in the range of 40° C.-80° C., preferably at about 45° C.-55° C., and mixing thoroughly until everything has dissolved.

The second oil phase and the first oil-in-water emulsion may be mixed together continuously to provide a final oil-in-water emulsion. Without being limited by theory, it is believed that a second oil-in-water emulsion, similar to the second oil-in-water emulsion provided in the above-described batch process, is formed inside the first emulsion during the mixing of the second oil phase and the first oil-in-water emulsion. Preferably, the second oil phase and the first oil-in-water emulsion are mixed while maintaining both the second oil phase and the first oil-in-water emulsion at a temperature above the crystallization temperature of the one or more added hard fats. Preferably, the second oil phase and the first oil-in-water emulsion are mixed at a temperature in the range of 40° C. to 80° C., preferably at about 45° C.-55° C., to provide a final oil-in-water emulsion. The resulting final oil-in-water emulsion is then mixed at the proper mixing speeds and mixing shears, and at a temperature in the range of 40° C. to 80° C., preferably at about 45° C.-55° C. (making sure not to drop below the crystallization temperature of the one or more added hard fats). The resulting final oil-in-water emulsion is preferably mixed until homogeneous. At this point the final emulsion may be quickly supercooled. Supercooling may be achieved using any suitable method, such as immersing the final emulsion into an ice/salt water bath or using a votator set at a temperature of about −5° C. to −15° C. Both methods will efficiently supercool the emulsion, however, it is important to note that the use of an expensive votator is optional. While not wishing to be limited by theory, it is believed that supercooling crystallizes the hard fat and stabilizes the released liquid oil (continuous oil phase) within a fat crystal network providing an oil-in-water-in-oil emulsion. Continuous supercooling and mixing is performed until the desired hardness and texture of the high liquid oil margarine is obtained. The desired hardness and texture is one that is suitable for spreadable tub-type margarines.

Mixing all of the above emulsions can be performed using any mechanical mixing apparatus in which the mixing or homogenization speed and shear can be controlled. A preferred mixing apparatus is a polytron or piston homogenizer.

In an embodiment of the invention, the process involving a first oil-in-water emulsion and a second oil phase is preferably applied in a continuous manufacturing process. A continuous process is suitable for application to the in-line manufacturing of a high liquid oil margarine. Suitably, an amount of the first oil-in-water emulsion may be prepared or provided and stored in a first holding tank at a temperature above the crystallization temperature of the one or more added hard fats. An amount of the second oil phase may also be prepared or provided and stored in a second holding tank at a temperature above the crystallization temperature of the one or more added hard fats. The amounts of the first oil-in-water emulsion and the second oil phase would be determined by the amount of margarine product to be made in a specified time period or “run”. The first oil-in water-emulsion and the second oil phase may then be continuously mixed and homogenized in an in-line processing unit using a proper disperser pump or a high shear pump to make the final oil-in-water emulsion. The homogenized final oil-in-water emulsion may be pumped directly into, for example, a votator, for supercooling and mixing. The final product may then exit the supercooling/mixing unit and be packaged using standard packaging equipment.

Margarine Products

In another of its aspects, the present invention provides a high liquid oil margarine wherein the total fat content of said high liquid oil margarine is made up of about 94-96% of one or more liquid oils and a maximum of about 4-6% of one or more added hard fats.

Preferably, the present invention provides a high liquid oil margarine wherein the total fat content of said high liquid oil margarine is made up of about 95% of one or more liquid oils and a maximum of about 5% of one or more added hard fats.

In a preferred embodiment of the present invention, the high liquid oil margarine is prepared using a process of the invention.

The following non-limiting examples are illustrative of the invention:

### EXPERIMENTAL EXAMPLES

### Example 1

Formulation:

| Ingredient | First Emulsion (%)* | Second Emulsion (%)* |
|---|---|---|
| Water | 8.0 | 18.0 |
| Sodium Caseinate | 0.25 | 0.25 |
| Sodium Benzoate | 0.015 | 0.015 |
| Sodium Chloride | — | 1.4 |
| Canola Oil | 46.0 | 30.0 |
| Lecithin | 0.05 | 0.05 |
| Monoglyceride | — | 0.05 |
| Sorbitan Tristearate | — | 0.047 |
| Butter Flavour | 0.2 | — |
| Whey Powder | — | 1.67 |
| Palm Stearin | — | 2.0 |
| Cotton Stearin | — | 2.0 |
| Beta-Carotene | — | 0.003 |

*percent by weight of the final mixture

Processing Procedures (Using Above Ratios):

First Emulsion

The first emulsion was an oil-in-water emulsion containing canola oil (with oil soluble ingredients) and water (with water soluble ingredients). An aqueous phase was prepared by warming water to about 45° C.-55° C. (not exceeding 80° C.) and adding sodium caseinate and sodium benzoate. The sodium caseinate and sodium benzoate were completely dissolved in the water by thoroughly mixing with a polytron homogenizer. An oil phase was prepared by dissolving lecithin and butter flavour in canola oil. An emulsion was prepared by gradually adding the oil phase to the warm aqueous phase with continuous mixing with the polytron homogenizer. The rate of addition was 20 mL/min at a homogenization speed of 20,000 rpm for a 50 mL emulsion. At this addition rate and homogenization speed there was no phase separation under the present conditions. Other addition rates and homogenization speeds may be preferred under other conditions, for example, when using different volumes.

Second Emulsion

The second emulsion is an oil-in-water emulsion containing canola oil (with oil soluble ingredients) and water (with water soluble ingredients). An aqueous phase was prepared by warming water to about 45° C.-55° C. (not exceeding about 80° C.) and adding sodium caseinate, sodium benzoate, sodium chloride and whey powder to provide a warm aqueous phase. The sodium caseinate, sodium benzoate, sodium chloride and whey powder were completely dissolved by thoroughly mixing with a polytron homogenizer. An oil phase was prepared by dissolving palm stearin, cotton stearin, lecithin, monoglyceride, sorbitan tristearate and beta-carotene in the canola oil at 45-55° C. to provide a warm oil phase. The second emulsion was prepared by gradually adding the warm oil phase to the warm aqueous phase with continuous mixing with the polytron homogenizer. The rate of addition was 20 mL/min at a homogenization speed of 20,000 rpm for a 50 mL emulsion. To prevent fat crystals from forming, the second emulsion was mixed at the above speed and at a temperature of about 45-55° C. until it was completely mixed with the first emulsion.

Mixing of the First and Second Emulsions

The temperature of both emulsions was kept above 45° C. because the second emulsion contained a hard fat fraction with a crystallization range of 45° C. to 48° C. Crystallization of the second emulsion prior to mixing with the first emulsion will prevent the formation the desired margarine product. A margarine was prepared by pouring the first emulsion into the second emulsion and careful mixing the two with the polytron homogenizer at a temperature above the crystallization temperature of the hard fat fraction until the two emulsions were completely mixed (about 2-3 min.) and then the temperature was lowered until a phase transition occurred. Phase transition was recognized by a significant drop in viscosity and a change in colour from white to off-yellow. At this point the mixture was quickly supercooled in an ice/salt water bath to crystallize the solid fat and stabilize the released liquid oil (continuous oil phase) with a fat crystal network. The resulting margarine was mixed with the homogenizer until desired hardness and texture was achieved.

### Example 2

Formulation:

| Ingredient | First Emulsion (%)* | Second Oil Phase(%)* |
|---|---|---|
| Water | 16 | — |
| Sodium Caseinate | 0.5 | — |
| Sodium Benzoate | 0.03 | — |
| Sodium Chloride | 1.4 | — |
| Canola Oil | 46.0 | 30.0 |
| Lecithin | 0.05 | 0.05 |
| Monoglyceride | — | 0.05 |
| Sorbitan Tristearate | — | 0.047 |
| Butter Flavour | 0.2 | — |
| Whey Powder | 1.67 | — |
| Palm Stearin | — | 2.0 |
| Cotton Stearin | — | 2.0 |
| Beta-Carotene | — | 0.003 |

*percent by weight of the final mixture

First Emulsion

The first emulsion was an oil-in-water emulsion containing canola oil (with oil soluble ingredients) and water (with water soluble ingredients). An aqueous phase was prepared by warming water to about 45° C.-55° C. (not exceeding 80° C.) and adding sodium caseinate, sodium benzoate, sodium chloride and whey powder. The sodium caseinate, sodium benzoate, sodium chloride and whey powder were completely dissolved in the water by thoroughly mixing with a polytron homogenizer. An oil phase was prepared by dissolving lecithin and butter flavour in canola oil. An emulsion was prepared by gradually adding the oil phase to the warm aqueous phase with continuous mixing with the polytron homogenizer. The rate of addition was 20 mL/min at a homogenization speed of 20,000 rpm for a 50 mL emulsion. At this addition rate and homogenization speed there was no phase separation under the present conditions. Other addition rates and homogenization speed may be preferred under other conditions, for example, when using different volumes.

Second Oil Phase

A second oil phase was prepared by dissolving lecithin, monoglyceride, sorbitan tristearate, palm stearin, cotton stearin and beta carotene in canola oil at a temperature of about 45° C.-55° C. (not exceeding 80° C.).

The second oil phase was added to the first oil-in-water emulsion at a temperature of about 45° C.-55° C. (not exceeding 80° C.) while mixing continuously until homogeneous, to provide a final oil-in-water emulsion. The final oil-in-water emulsion was poured into a cooled mixer. Continuous supercooling, mixing and working was performed until a solid form of high liquid oil margarine was obtained.

While the present invention has been described with reference to what are presently considered to be the preferred examples, it is to be understood that the invention is not limited to the disclosed examples. To the contrary, the invention is intended to cover various modifications and equivalent arrangements included within the spirit and scope of the appended claims.

We claim:

1. A process for the preparation of a high liquid oil margarine wherein the total fat content of the margarine comprises about 94-96% of one or more liquid oils and a maximum of about 4-6% of one or more added hard fats, the process comprising the steps of:
(I) combining a first oil-in-water emulsion and a second oil-in-water emulsion at a temperature above the crystallization temperature of the one or more added hard fats and mixing to provide a mixture, wherein said first oil-in-water emulsion comprises between about 55% to about 80% of total liquid oil in the margarine and the second oil-in-water emulsion comprises between about 20% to about 45% of total liquid oil in the margarine and essentially all of the one or more added hard fats in the margarine;
(II) reducing the temperature of the mixture and mixing until a phase transition occurs; and
(III) supercooling and mixing to obtain a high liquid oil margarine.

2. The process according to claim 1, wherein the first oil-in-water emulsion further comprises about 45%-55% of total water in the margarine, one or more water soluble emulsifying agents and one or more oil soluble emulsifying agents.

3. The process according to claim 1, wherein the second oil-in-water emulsion further comprises about 45%-55% of total water in the margarine, one or more water soluble emulsifying agents and one or more oil soluble emulsifying agents.

4. The process according to claim 1, wherein the one or more liquid oils is selected from the group consisting of canola oil, high oleic sunflower oil, sunflower oil, safflower oil, fish oil, soybean oil, cotton oil, corn oil, olive oil, peanut oil and mixtures thereof.

5. The process according to claim 4, wherein the one or more liquid oils is selected from the group consisting of canola oil, high oleic sunflower oil, sunflower oil, safflower oil, corn oil and mixtures thereof.

6. The process according to claim 5, wherein the one or more liquid oils is canola oil.

7. The process according to claim 1, wherein the one or more added hard fats is selected from the group consisting of palm stearin, cotton stearin, corn stearin, canola stearin and mixtures thereof.

8. The process according to claim 7, wherein the one or more added hard fats is a mixture comprising palm stearin.

9. The process according to claim 6, wherein the one or more added hard fats is selected from a mixture of palm stearin and cotton stearin and a mixture of palm stearin and canola stearin.

10. The process according to any one of claims 2 and 3, wherein the one or more water soluble emulsifying agents is selected from the group consisting of sodium caseinate, whey protein isolates and soy protein isolates.

11. The process according to claim 10, wherein the one or more water soluble emulsifying agents is sodium caseinate.

12. The process according to any one of claims 2 and 3, wherein the one or more oil soluble emulsifying agents are selected from lecithin, phospholipids, monoglyceride and diglyceride.

13. The process according to claim 2, wherein the one or more oil soluble emulsifying agents is lecithin.

14. The process according to claim 3, wherein the one or more oil soluble emulsifying agents are monoglyceride and lecithin.

15. The process according to claim 2, wherein the first oil-in-water emulsion further comprises one or more preservatives and one or more flavouring agents.

16. The process according to claim 15, wherein the one or more preservatives is sodium benzoate.

17. The process according to claim 15 wherein the one or more flavouring agents is butter flavour.

18. The process according to claim 2, wherein the second oil-in-water emulsion further comprises one or more crystal modifiers, one or more colouring agents and one or more flavouring agents.

19. The process according to claim 18, wherein the one or more crystal modifiers is sorbitan tristearate.

20. The process according to claim 28, wherein the one or more colouring agents is beta-carotene.

21. The process according to claim 16, wherein the one or more flavouring agents is whey powder.

22. The process according to claim 1, wherein the temperature for the combining of the second oil-in-water emulsion and the first oil-in-water emulsion is in the range of 45° C. to 80° C.

23. A process for the preparation of a high liquid oil margarine wherein the total fat content of the margarine comprises about 94-96% of one or more liquid oils and a maximum of about 4-6% of one or more added hard fats, comprising the steps of:
(I) preparing a first oil-in-water emulsion comprising the steps of:
(a) providing an aqueous phase comprising about 2%-4% by weight of one or more water soluble emulsifying agents, about 0.1%-0.2% by weight of one or more preservatives and the remainder being essentially water;
(b) providing an oil phase comprising about 0.05%-0.4% by weight of one or more oil soluble emulsifying agents, about 0.3%-0.5% by weight of one or more flavouring agents and the remainder being essentially one or more liquid oils; and
(c) combining the oil phase and the aqueous phase at a temperature in the range of about 40° C. to about 80° C. to provide the first oil-in-water emulsion;
wherein the aqueous phase of the first oil-in-water emulsion comprises about 45%-55% of total water in the margarine and the oil phase of the first oil-in-water emulsion comprises about 55%-80% of total liquid oil in the margarine;
(II) preparing a second oil-in-water emulsion comprising the steps of:
(a) providing an aqueous phase comprising about 2%-4% by weight of one or more water soluble emulsifying agents, about 0.1%-0.2% by weight of one or more preservatives, about 10%-13% by weight of sodium chloride, about 13%-15% by weight of one or more flavouring agents and the remainder being essentially water;
(b) providing an oil phase comprising about 11%-15% by weight of one or more added hard fats, about 0.2%-0.6% by weight of one or more oil soluble emulsifying agents, 0.1%-0.3% by weight of one or more crystal modifiers and the remainder being essentially one or more liquid oils; and
(c) combining the oil phase and the aqueous phase, while both phases are kept at a temperature above the crystallization temperature of the one or more added hard fats, to provide the second oil-in-water emulsion;
wherein the aqueous phase of the second oil-in-water emulsion comprises about 45%-55% of total water in the margarine and the oil phase of the second oil-in-water emulsion comprises about 20%-45% of total liquid oil in the margarine and essentially all of the one or more added hard fats in the margarine;
(III) combining the first oil-in-water emulsion and the second oil-in-water emulsion, while keeping both emulsions at a temperature above the crystallization temperature of the one or more added hard fats, to produce a mixture;
(IV) reducing the temperature of the mixture and mixing until a phase transition occurs; and
(V) supercooling the mixture and mixing to obtain a high liquid oil margarine.

24. A process for the preparation of a high liquid oil margarine wherein the total fat content of the margarine comprises about 94-96% of one or more liquid oils and a maximum of about 4-6% of one or more added hard fats, the process comprising the steps of:
I) combining a second oil phase and a first oil-in-water emulsion at a temperature above the crystallization temperature of the added one or more hard fats to provide a final oil-in-water emulsion, wherein said first oil-in-water emulsion comprises about 55-80% of total liquid oil in the margarine and essentially all of the water in the margarine and the second oil phase comprises about 20-45% of total liquid oil in the margarine and essentially all of the one or more added hard fats in the margarine, to provide a final oil-in-water emulsion; and
(II) supercooling the final oil-in-water emulsion and mixing to obtain a high liquid oil margarine.

25. The process according to claim 24, wherein the first oil-in-water emulsion further one or more water soluble emulsifying agents and one or more oil soluble emulsifying agents.

26. The process according to claim 24, wherein the second oil phase further comprises one or more oil soluble emulsifying agents.

27. The process according to claim 24, wherein the one or more liquid oils is selected from the group consisting of canola oil, high oleic sunflower oil, sunflower oil, safflower oil, fish oil, soybean oil, cotton oil, corn oil, olive oil, peanut oil and mixtures thereof.

28. The process according to claim 27, wherein the one or more liquid oils is selected from the group consisting of canola oil, high oleic sunflower oil, sunflower oil, safflower oil, corn oil and mixtures thereof.

29. The process according to claim 28, wherein the one or more liquid oils is canola oil.

30. The process according to claim 24, wherein the one or more added hard fats is selected from the group consisting of palm stearin, cotton stearin, corn stearin, canola stearin and mixtures thereof.

31. The process according to claim 30, wherein the one or more added hard fats is a mixture comprising palm stearin.

32. The process according to claim 31 wherein the one or more added hard fats is selected from a mixture of palm stearin and cotton stearin and a mixture of palm stearin and canola stearin.

33. The process according to claim 25, wherein the one or more water soluble emulsifying agents is selected from the group consisting of sodium caseinate, whey protein isolates and soy protein isolates.

34. The process according to claim 33, wherein the one or more water soluble emulsifying agents is sodium caseinate.

35. The process according to any one of claims 25 and 26, wherein the one or more oil soluble emulsifying agents are selected from lecithin, phospholipids, monoglyceride and diglyceride.

36. The process according to claim 25, wherein the one or more oil soluble emulsifying agents is lecithin.

37. The process according to claim 26, wherein the one or more oil soluble emulsifying agents are monoglyceride and lecithin.

38. The process according to claim 25, wherein the first oil-in-water emulsion further comprises one or more preservatives and one or more flavouring agents.

39. The process according to claim 38, wherein the one or more preservatives is sodium benzoate.

40. The process according to claim 38, wherein the one or more flavouring agents is selected from butter flavour and whey powder.

41. The process according to claim 38, wherein the first oil-in-water emulsion further comprises sodium chloride.

42. The process according to claim 26, wherein the second oil phase further comprises one or more crystal modifiers and one or more colouring agents.

43. The process according to claim 42, wherein the one or more crystal modifiers is sorbitan tristearate.

44. The process according to claim 42, wherein the one or more colouring agents is beta-carotene.

45. The process according to claim 24, wherein the temperature for the combining of the second oil phase and the first oil-in-water emulsion is in the range of 45° C. to 80° C.

46. A process for the preparation of a high liquid oil margarine wherein the total fat content of the margarine comprises about 94%-96% of one or more liquid oils and a maximum of about 4%-6% of one or more added hard fats, the process comprising the steps of
In a further aspect of the present invention there is provided a continuous process for the preparation of a high liquid oil margarine wherein the total fat content of the margarine comprises about 94%-96% of one or more liquid oils and a maximum of about 4%-6% of one or more added hard fats, the process comprising the steps of
(I) preparing a first oil-in-water emulsion comprising the steps of:
(a) providing an aqueous phase comprising about 2.5%-10% by weight of one or more water soluble emulsifying agents, about 0.1%-0.2% by weight of one or more preservatives, about 6.2%-12.5% by weight of sodium chloride, about 6.2%-12.5% by weight of whey powder and the remainder being essentially water;
(b) providing a first oil phase comprising about 0.05%-0.4% by weight of one or more oil soluble emulsifying agents, about 0.3%-0.5% by weight of one or more flavouring agents and the remainder being essentially one or more liquid oils; and
(c) combining the first oil phase and the aqueous phase at a temperature in the range of about 40° C. to about 80° C. to provide the first oil-in-water emulsion;
wherein the aqueous phase comprises essentially all of the water in the margarine and the first oil phase comprises about 55%-80% of total liquid oil in the margarine;
(II) providing a second oil phase comprising about 11%-15% by weight of one or more added hard fats, about 0.2%-0.6% by weight of one or more oil soluble emulsifying agents, 0.1%-0.3% by weight of one or more crystal modifiers, and the remainder being essentially one or more liquid oils;
wherein the second oil phase comprises about 20%-45% of total liquid oil in the margarine and essentially all of the added hard fats in the margarine;
(III) combining the first oil-in-water emulsion and the second oil phase while keeping the first oil-in-water emulsion and the second oil phase at a temperature above the crystallization temperature of the one or more added hard fats, to provide a final oil-in-water emulsion; and
(IV) supercooling the final oil-in-water emulsion and mixing to obtain a high liquid oil margarine.

47. The process according to claim 24, where in the second oil phase and the first oil-in-water emulsion are combined in a continuous process.

48. A high liquid oil margarine wherein the total fat content of said high liquid oil margarine is made up of about 94-96% of one or more liquid oils and a maximum of about 4-6% of one or more added hard fats.

49. A high liquid oil margarine wherein the total fat content of said high liquid oil margarine is made up of about 95% of one or more liquid oils and a maximum of about 5% of one or more added hard fats.

50. A high liquid oil margarine prepared using a process according to any one of claims 1-44.
